(19) United States
(12) Patent Application Publication
(10) Pub. No.: US 2016/0303575 A1
(43) Pub. Date: Oct. 20, 2016

(54) RECORDABLE MEDIA DESTRUCTION SYSTEM AND METHOD

(71) Applicant: EOL IT SERVICES LTD, Malton Essex (GB)

(72) Inventor: JANICE MARGARET SMITH, Maldon Essex (GB)

(73) Assignee: EOL IT SERVICES LTD, Malton Essex (GB)

(21) Appl. No.: 15/103,488

(22) PCT Filed: Nov. 25, 2014
(86) PCT No.: PCT/GB2014/053482

§ 371 Date: Jun. 10, 2016

(30) Foreign Application Priority Data
Dec. 10, 2013 (GB) 1321836.7

(51) Int. Cl. B02C 18/00; G06F 21/32; G06F 21/62; B02C 25/00

(52) U.S. Cl. CPC B02C 18/0007; B02C 25/00; G06F 21/32; G06F 21/6218; B02C 2018/0015

(57) ABSTRACT

A system for rendering data recorded on recordable media unreadable, the recordable media having a unique identifier, the system comprising:—means for reading said unique identifier from a recordable medium (104);—means for comparing said read unique identifier with a stored record of one or more unique identifiers of recordable media required to be processed (109);—means for generating an output indicative of whether or not said read unique identifiers matches one of said one or more unique identifiers in said stored record; and—means for rendering data recorded on a recordable medium unreadable only if said read unique identifier matches one of said one or more unique identifiers in said stored record (110).

This invention relates generally to a system and method for the secure destruction of recordable media.

Data storage technologies have progressed in recent years and many different types of data recording media have been developed. With the progress of computer-associated technologies, large-capacity recording media such as hard disks and media cards have been developed. However, when such recording media is no longer required, and must therefore be discarded, it is often crucial that the data stored thereon, which may be sensitive or confidential, is destroyed or at least rendered unreadable.

Systems and methods have been described for destroying recording media. For example, European patent application EP1712304 describes a system for destroying, by punching, a recording medium. A video camera is positioned within the system so that when an operator approaches it, a record of their identity is captured, plus an image of the medium being destroyed is obtained, including the manufacturer's number printed on the surface, for use in generating a certificate of destruction at the end of the process. The object of the overall method is to securely destroy the media, leaving a record of what was actually destroyed and who it was destroyed by. However, there are a number of drawbacks associated with this system, which adversely affect its overall security and effectiveness.

Firstly, there is no security check regarding the identity of the operative prior to destruction of a medium. Also, there is no verification prior to destruction (or even afterwards) that the medium being destroyed is, in fact, the medium required to be destroyed: the identification number printed on the surface of the disk is not checked and verified prior to destruction and, in any event, could be replicated and provided on a duplicate disk if a security breach occurs.

The present invention seeks to address these issues and alleviate at least some of the problems outlined above. Thus, in accordance with a first aspect of the present invention, there is provided a system for the destruction of recordable media, the recordable media having a unique identifier, the system comprising:
means for reading said unique identifier from a recordable medium;
means for comparing said read unique identifier with a stored record of one or more unique identifiers of recordable media required to be destroyed;
means for generating an output indicative of whether or not said read unique identifier matches one of said one or more unique identifiers in said stored record; and
means for destroying a recordable medium only if said read unique identifier matches one of said one or more unique identifiers in said stored record.

Thus, by providing a check, prior to destruction of a medium, the possibility of a security breach going undetected, or a medium being mistakenly destroyed, is significantly reduced.

In a preferred embodiment, the means for destroying a recordable medium is a shredding device. This improves the general automation of the device. In fact, in one preferred embodiment, the entire system is automated from the time that a user places a medium into the system until it has been destroyed. Thus, in one exemplary embodiment, the system includes a compartment for receiving a recordable medium, wherein the compartment has therein a reading means for automatically reading a unique identifier from the medium. The unique identifier may be in the form of a barcode, in which case the reading means is a barcode scanner, but the identifier may alternatively be an alphanumeric code, in which case the reading means might be an image capture device and the system may include character recognition means for reading the unique identifier within a captured image. In a preferred embodiment, irrespective of the nature of the unique identifier, an image capture device is preferably provided within the compartment for capturing an image of the medium being destroyed, to be stored as evidence for future reference if required. Reading means and/or image capture devices may be located at each side wall of an elongate compartment configured to receive a recordable medium sideways on, such that irrespective of which way the medium is inserted into the compartment, the unique identifier can be read and an image thereof can be captured.

Alternatively (or in addition), the system may include external reading means, such as a barcode scanner or image capture means and character recognition software, to enable a user to manually effect the reading of the unique identifier by the system.

The compartment for receiving a medium to be destroyed is preferably provided with means for electronically locking said medium in place, once inserted. Means are beneficially provided for automatically moving said medium to a shredding location within the system. The shredding location preferably comprises a further compartment within which a shredding device is provided, the compartment preferably comprising a hatch which is caused to open only if said read unique identifier matches one of said one or more unique identifiers in said stored record. Thus, once the medium is inserted into the compartment, there is no need or scope for further human intervention until after the shredding process is complete. If not, the system preferably includes means for generating an error signal and transmitting it to a central control station, to trigger and alert, for example, an email or SMS to a senior operator. The system may be configured such that when an error signal has been generated, the system is disabled unless and until an authorised senior operator has successfully overridden the error and reset the system.

The system preferably comprises authentication means for identification of an authorised user prior to permitting insertion of a medium into the compartment. Thus, the compartment preferably comprises an electronically lockable hatch which opens only if a signal is received indicating that the user is an authorised user. The authentication means may require entry of a correct password, scanning of an authorised identity card, and/or biometric identification means, such as a fingerprint scanner or the like. Irrespective of the manner in which authentication is effected, the system beneficially includes means for comparing identification data received a stored record of identification data for one or more authorised users and generating an output signal indicative of whether or not identification data entered matches the identification data of one of the one or more authorised users. If a match is detected, the electronically lockable hatch is unlocked and the user is able to insert a medium for destruction. If there is no match, an error signal is preferably transmitted to a central control station.

The system may include an image capture device, preferably a video camera or the like, which captures images of a user during a destruction process. Image data from said image capture device is beneficially transmitted to the central control station and stored, for use as evidence if required.

The system beneficially comprises a waste receptacle for receiving remnants of said recordable media after shredding.

In a preferred embodiment, the system includes the central control station which provides an audit trail of a medium from its source to the waste receptacle. Beneficially, means are provided for entering the unique identifier of a medium to be destroyed and time stamping said entry, and means are further provided for generating an alert signal if, after a predetermined period of time, the control station has not received data confirming the destruction of said medium.

The waste receptacle is preferably mounted in or on a weighing scale for measuring the weight thereof and generating a signal indicative of said weight. Means are preferably further provided for generating an alert signal when said weight exceeds a predetermined threshold, thereby providing an indication that the waste receptacle requires collection and emptying. The system beneficially includes an electronically lockable bin access door, and means for identifying an authorised user which causes said bin access door to be unlocked only if an authorised user is successfully identified.

Embodiments of the present invention will now be described by way of examples only and with reference to the accompanying drawings, in which:

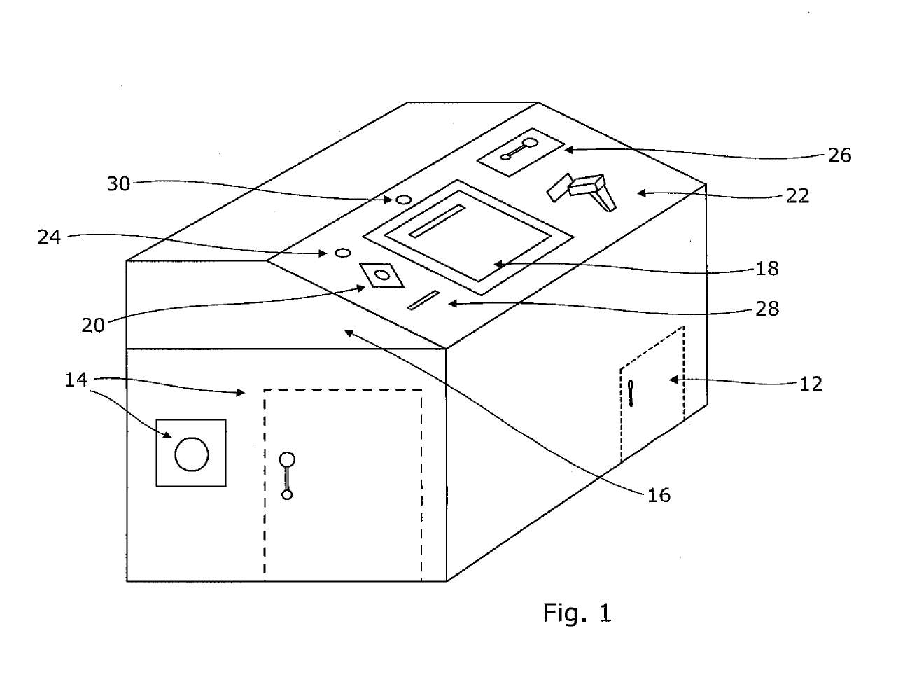

FIG. 1 is a schematic diagram of a system according to an exemplary embodiment of the present invention; and

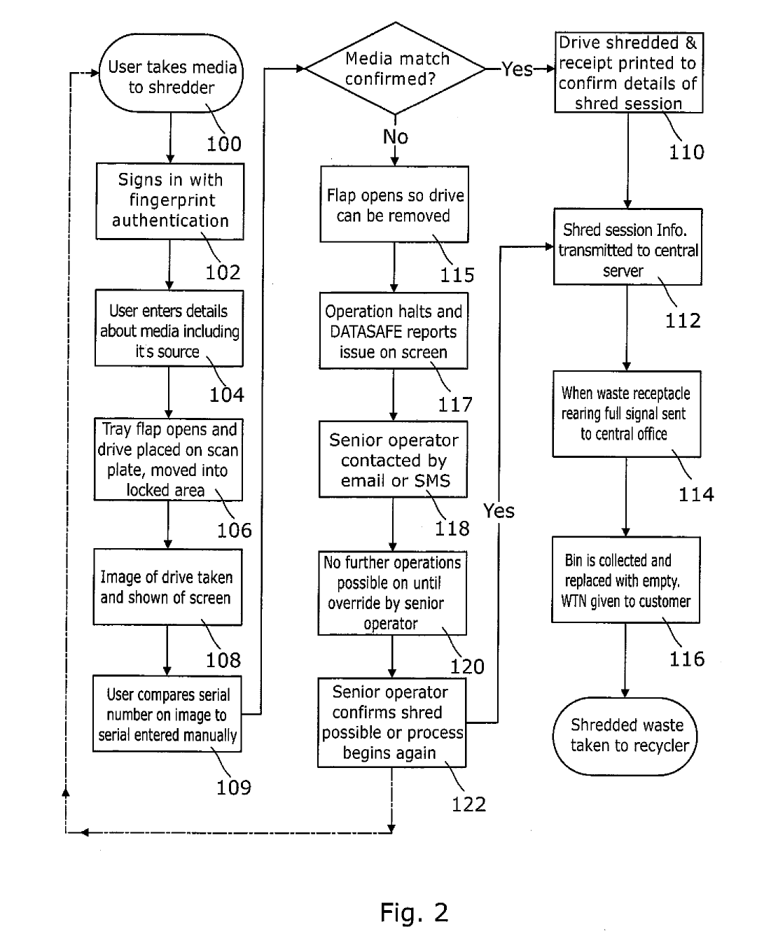

FIG. 2 is a schematic flow diagram of a method according to an exemplary embodiment of the present invention.

Referring to FIG. 1 of the drawings, a system according to an exemplary embodiment of the present invention comprises a housing 10 within which is housed a waste receptacle (not shown) having an access door 12. A power box and switch 14 are also provided. A hinged component hatch 16 is provided on an upper surface of the housing 10, which is electronically locked and can only be opened upon receipt of a signal from the security system housed within the unit. Within the component hatch 16, there is mounted a touch-screen display 18 linked to a web-based front end access system, for displaying the current status of a shredding operation to a user and allowing a user to enter data as required. Also mounted within the component hatch 16, is a transparent screen 20, below which is mounted (within the unit) a fingerprint scanner and authentication system (not shown). The system further comprises a handheld barcode scanner 22, which may be in wireless or hard wired communication with the internal system control module. An emergency stop button 24 is provided in case of emergency, and the component hatch 16 includes an output slot 28 for outputting printed matter from the internal control module, such as a shredding receipt or media identification information. Finally, a drive tray 26 for holding a stack of media to be shredded is provided at a convenient location on the unit 10. The unit itself can be made readily mobile, and the power supply could be a single phase supply or a three phase supply and generator.

Referring additionally to FIG. 2 of the drawings, in use, at step 100, the user takes the media to be shredded to the system. At step 102, the user presents their fingertip to the fingerprint reader so that their fingerprint can be authenticated. It will be appreciated that fingerprint recognition systems are known and the manner in which such fingerprint authentication is performed is not critical to the invention. Thus, the invention is not intended to be limited in this regard. However, for completeness, the user places their fingertip on a glass window, beneath which is provided a scanner, such as an optical or capacitive scanner, which captures an image of the user's fingerprint. Most fingerprint scanner systems then compare specific features of the fingerprint, generally known as minutiae. The scanner system software within the internal control module uses algorithms to recognize and analyze these minutiae. For example, if two prints have three ridge endings and two bifurcations, forming the same shape with the same dimensions, there's a high likelihood they're from the same print. To get a match, the scanner system does not have to find the entire pattern of minutiae both in the sample and in the print on record, it simply has to find a sufficient number of minutiae patterns that the two prints have in common. The exact number varies according to the scanner programming.

It will be appreciated that the fingerprint recognition system used in the present invention could be used in conjunction with, or instead of, a password or identity card access protocol. Biometric systems like fingerprint scanners have a number of advantages over other systems, such as:
Physical attributes are much harder to fake than identity cards.
A fingerprint pattern cannot be guessed like a password.
Fingerprints, irises or voice cannot be misplaced or stolen, like an access card.
Fingerprints cannot be forgotten like a password

Once the internal control system has successfully verified the identity of an authorised operator by comparing identification data supplied with authorised user identification data stored in a remote central server, the user scans the barcode on the media, using the system's barcode scanner, at step 104. The data represented by the barcode contains a unique identifier for the media and, as such, this identifier can be compared against the record of media to be shredded.

If there is no match, the process halts and no further action can be taken unless and until a senior operator overrides the system.

However, if the identifiers are determined to match, the tray flap opens, at step 106, and the operator can place the media on the scan plate, where it is moved into a locked area. An image of the media is taken, at step 108 by an internal camera or scanner, and the unique identifier for the media is checked at step 109 against the identifier entered via the barcode scanner at step 104.

If there is no match, the process halts and no further action can be taken unless and until a senior operator overrides the system.

However, if the identifiers are determined to match, the media is shredded and the remnants are deposited into the waste bin. The internal camera or scanner records image data of each medium as it is moved within the unit into a shredding chamber. A receipt is printed, at step 110, by an internal printer (not shown) to confirm details of the shred session and the receipt is output via the slot 28 in the component hatch 16. Such a receipt might include information regarding the media and its source, as well as the date of shredding and the operator who performed the shredding operation. Shred session data is also transmitted, at step 112, to a remote central server, beneficially in the form of an SQL-based database, where it is stored, together with an image of the operator who performed the shredding session, which is captured by a suitably positioned video camera (FIG. 1, 30) throughout the session, wherein image data from the camera is communicated, via a hard wired or wireless communication path, to the central control module. This video camera may also be used for facial operator authentication, in addition or as an alternative to the fingerprint scanning, and it may also be linked to a real-time CCTV system within a monitoring station. In any event, it will be appreciated that the provision of the video camera provides real-time user facial identification whilst shredding is attempted or in process.

The location at which it is decided that a particular medium is to be destroyed may be remote from the location of the system of the present invention, for example, off site at a customer's premises. As a result, the time between that decision being made and the actual destruction of the medium can be significant, during which the medium may pass through many hands, and it may become lost. Therefore, the central server is arranged to receive data input by authorised personnel in the form of identification numbers of media required to be shredded, and this data is time stamped and then monitored: in the event that the server has not received confirmation within a predetermined time, say 24 hours, that a particular medium has been successfully shredded, an alert is generated. The central server is also arranged to receive a signal from the system in the event of an error, such as the attempted access by an unauthorised operative, the attempted shredding of a medium having an incorrect serial number, or the activation of the emergency stop function. Upon receipt of such a signal, the destruction process is halted, at step 117, the tray flap opens, at step 115, so that the media can be removed, and the server may be arranged to send (at step 118) an automated message to a selected senior operator, and the system may be arranged such that it can only be re-started by means of an override function performed by that senior operator (steps 120 and 122).

The waste receptacle, which is located within the housing 10 and arranged to receive the remnants of the shredded media, is mounted on an electronic weighing scale (not shown) within the housing 10, and the output of the weighing scale is, in turn, connected to the central control module which is arranged to provide a signal, such as a lit LED or audible alarm when the waste receptacle reaches a predetermined weight (at step 114), to indicate to a user that the receptacle is required to be emptied. An alert, possibly in the form of an email or other automated message, may additionally or alternatively be transmitted elsewhere within an organisation in order to alert relevant personnel that waste collection is required.

The bin access door 12 is electronically locked and can only be opened by authorised personnel (which is also the case for the access door 14). Thus, when the waste receptacle is required to be accessed and removed for emptying, an authorised operative is required to identify themselves to the system by means of a password, entered by means of the touch-screen display 18, and/or by means of the fingerprint scanning system provided on the component hatch 16. Once access to the waste receptacle has been gained by an authorised operative (at step 116), the central control module may be arranged to create and output a waste transfer note, which may be in the form of a schedule or record of information relating to the shredded material within the receptacle, such as, for example, media identification numbers, source, date of shredding and an indication of the operator that performed the shredding operation(s). This data may also be transmitted as a complete record to the SQL-based database for storage, together with the date on which the receptacle is collected, an indication of the operator that collected the receptacle and, optionally, image data of the operator captured by the video camera, as required.

It will be appreciated that the term recordable media is a known term and is intended to encompass magnetically and optically recordable media, compact disks (CDs), digital versatile disks (DVDs), hard drives (HDs) and mobile phones and similar communication devices, and the present invention is not intended to be limited in this regard.

It will of course be understood that the present invention has been described above by way of examples only and it will be readily apparent to persons skilled in the art that modifications can be made without departing from the scope of invention as defined by the claims.

1-30. (canceled)

31. A system for rendering data recorded on recordable media unreadable, the recordable media having a unique identifier, the system comprising:
a module configured to read said unique identifier from a recordable medium;
a comparison module configured to compare said read unique identifier with a stored record of one or more unique identifiers of recordable media required to be processed;
a processor configured to generate an output indicative of whether or not said read unique identifiers matches one of said one or more unique identifiers in said stored records; and
a module configured to render data recorded on a recordable medium unreadable only if said read unique identifier matches one of said one or more unique identifiers in said stored record.

32. A system according to claim 31, wherein said module for rendering data recorded on said recordable medium unreadable comprises a destruction device for destroying said medium, the system further comprising a waste receptacle for receiving remnants of recordable media after destruction thereof.

33. A system according to claim 32, wherein said waste receptacle is mounted in or on a weighing scale for determining the weight of said receptacle, and providing an output indicative of said weight, wherein the system further comprises an input module configured to receive said signal and compare said weight with a predetermined threshold value, and generating an alert signal when said weight exceeds said predetermined threshold.

34. A system according to claim 31, further comprising an authorised user authentication module configured to receive data from a prospective user and compare said data with a stored record of data relating to one or more authorised users, and to generate an output indicative of whether or not said received data matched the data of one of said one or more authorised users, wherein the system is configured such that said module for rendering the data on said recordable medium unreadable is only made operative if said received data matched the data of an authorised user.

35. A system for the destruction of recordable media, comprising a destruction device for destroying said recordable medium, a waste receptacle for receiving remnants of recordable media after destruction thereof, said waste receptacle being mounted in or on a weighing scale for determining the weight of said receptacle and providing an output indicative of said weight, and an alert module configured to generate an alert when said weight exceeds a predetermined threshold value.

36. A system according to claim 32, wherein said destruction device for destroying a recordable medium is a shredding device.

37. A system according to claim 36, wherein said recordable media each have a unique identifier, and the system further comprises a reading device for reading said unique identifier from a recordable medium, a comparison module for comparing said read unique identifier with a stored record of one or more unique identifiers of recordable media required to be destroyed, and a processor for generating an output indicative of whether or not said read unique identifier matches one of said one or more unique identifiers in said stored records, wherein said destruction device for destroying a recordable medium is configured to destroy said recordable medium only if said read unique identifier matches one of said unique identifiers in said stored record.

38. A system according to claim 31, including a compartment for receiving a recordable medium wherein said compartment has therein a reading device for reading a unique identifier from said medium.

39. A system according to claim 31, including image capture device for capturing images of said system and an area adjacent said system.

40. A system according to claim 31, further comprising a manually operable reading module for reading a unique identifier from a recordable medium.

41. A system according to claim 38, wherein said compartment comprises an electronically lockable hatch which is configured to open for receipt of a recordable medium only if the unique identifier thereon matches one of one or more unique identifiers in a stored records of recordable media to be destroyed.

42. A system according to claim 31, comprising a device for transporting a recordable medium inserted therein by a user to a destruction location within said system.

43. A system according to claim 42, wherein said destruction location comprises an electronically lockable hatch which is configured to open for receipt of a recordable medium only if the unique identifier thereon matches one of one or more unique identifiers in a stored record of recordable media to be destroyed.

44. A system according to claim 31, wherein if the read identifier on a recordable medium does not match one of one or more unique identifiers in the stored record, an error signal is generated and transmitted to a central control station; and
wherein the stored record is stored in said central control station and the system is configured to transmit a record of a medium destruction process, in the form of data representative of at least one unique identifier of a recordable medium and the identity of a user that performed the destruction process, back to said central control system for storage.

45. A system according to claim 34, wherein the system comprises an electronically lockable hatch for permitting selective access to said waste receptacle, the system further comprising authorised user authentication means for receiving data from a prospective user and comparing said data with a stored record of data relating to one or more authorised users, and for generating an output indicative of whether or not said received data matches the data of one of said one or more authorised users, wherein said lockable hatch is operative to only allow access to said waste receptacle if the received user matched the data of one of said authorised users.

46. A system according to claim 34, wherein authorised user authentication module comprises a biometric authentication device.

47. A method for rendering data recorded on a recordable media unreadable, the recordable media having a unique identifier the method comprising:
reading said unique identifier from a recordable medium;
comparing said read unique identifier with a stored record of one or more unique identifiers of recordable media required to be processed;
generating an output indicative of whether or not said read unique identifier matches one of said one or more unique identifiers in said stored record; and
rendering data recorded on a recordable medium unreadable only if said read unique identifier matches one of said one or more unique identifiers in said stored record.

48. A method according to claim 47, further comprising providing a central control station including a database on which is stored data representative of the unique identifiers all recordable media to be destroyed, and data representative of all users authorised to perform the destruction process.

49. A method according to claim 47, wherein said data representative of authorised users comprises biometric data, and the method further comprises rendering data recorded on a recordable medium unreadable only if said prospective user is an authorised user.

50. A method according to claim 47, including the steps of entering data representative of the unique identifier of one or more recordable media to be destroyed, and obtaining data representative of a user wishing to perform a destruction process, comparing said obtained data with respective data stored in said database, and generating an output indicative of whether or not said prospective user is an authorised user.
